(19) United States
(12) Patent Application Publication
(10) Pub. No.: US 2025/0148584 A1
(43) Pub. Date: May 8, 2025

(54) QUALITY INSPECTION SYSTEM, QUALITY INSPECTION METHOD, AND STORAGE MEDIUM

(71) Applicant: NEC Corporation, Tokyo (JP)

(72) Inventor: Kousuke Morishita, Tokyo (JP)

(73) Assignee: NEC Corporation, Tokyo (JP)

(21) Appl. No.: 18/929,796

(22) Filed: Oct. 29, 2024

(30) Foreign Application Priority Data
Nov. 8, 2023 (JP) 2023-190997

(51) Int. Cl. G06T 7/00

(52) U.S. Cl. CPC G06T 7/0004; G06T 2207/20021; G06T 2207/20081; G06T 2207/30108

(57) ABSTRACT

A quality inspection system includes: an acquisition unit that acquires an image captured of a wall material; a division unit that divides the image into a plurality of small images; a detection unit that detects a defect included in the wall material by referring to a combination of at least two determination results which have been obtained by inputting the small images into each of at least two machine learning models that have been trained by different training methods; and an output unit that outputs a detection result.

This Nonprovisional application claims priority under 35 U.S.C. § 119 on Patent Application No. 2023-190997 filed in Japan on Nov. 8, 2023, the entire contents of which are hereby incorporated by reference.

### TECHNICAL FIELD

The present disclosure relates to a quality inspection system, a quality inspection method, and a storage medium.

### BACKGROUND ART

There have been known techniques for detecting defects in building materials. For example, Patent Literature 1 describes a decorative material repair apparatus that detects a defect in a decorative material which is a building material and which has a pattern having irregularities on a surface of a base material. The decorative material repair apparatus described in Patent Literature 1 detects a defect in the decorative material by making a comparison between imaging data obtained by capturing an image of a surface of the decorative material and reference data stored in advance.

### CITATION LIST

### Patent Literature

### [Patent Literature 1]

Japanese Patent Application Publication Tokukai No. 2008-201073

### SUMMARY OF INVENTION

### Technical Problem

In the decorative material repair apparatus described in Patent Literature 1, it is not assumed to detect a small dent made in a wall material having a large size, such as, for example, a defect (e.g., dust, scratches, and the like) of about 1 mm on a wall material measuring approximately 1 m by 3 m. That is, in the decorative material repair apparatus described in Patent Literature 1, there is a problem in the accuracy of detecting a defect in a wall material.

The present disclosure has been made in view of the above problem, and an example object of the present disclosure is to provide a technique of improving the accuracy of detecting a defect in a wall material.

### Solution to Problem

A quality inspection system in accordance with an example aspect of the present disclosure includes at least one processor, the at least one processor carrying out: an acquisition process for acquiring an image captured of a wall material; a division process for dividing the image into a plurality of small images; a detection process for detecting a defect included in the wall material by referring to a combination of at least two determination results which have been obtained by inputting the small images into each of at least two machine learning models that have been trained by different training methods and that each use, as input, an image captured of a wall material and output a determination result which is obtained by determining whether or not the wall material is defective; and an output process for outputting a detection result which is obtained in the detection process.

A quality inspection method in accordance with an example aspect of the present disclosure includes: an acquisition process for at least one processor acquiring an image captured of a wall material; a division process for the at least one processor dividing the image into a plurality of small images; a detection process for the at least one processor detecting a defect included in the wall material by referring to a combination of at least two determination results which have been obtained by inputting the small images into each of at least two machine learning models that have been trained by different training methods and that each use, as input, an image captured of a wall material and output a determination result which is obtained by determining whether or not the wall material is defective; and an output process for the at least one processor outputting a detection result which is obtained in the detection process.

A storage medium in accordance with an example aspect of the present disclosure is a computer-readable non-transitory storage medium storing a program for causing a computer to function as a quality inspection system, the program causing the computer to carry out: an acquisition process for acquiring an image captured of a wall material; a division process for dividing the image into a plurality of small images; a detection process for detecting a defect included in the wall material by referring to a combination of at least two determination results which have been obtained by inputting the small images into each of at least two machine learning models that have been trained by different training methods and that each use, as input, an image captured of a wall material and output a determination result which is obtained by determining whether or not the wall material is defective; and an output process for outputting a detection result which is obtained in the detection process.

### Advantageous Effects of Invention

An example aspect of the present disclosure brings about an example effect of making it possible to provide a technique of improving the accuracy of detecting a defect in a wall material.

### BRIEF DESCRIPTION OF DRAWINGS

FIG. 1 is a block diagram illustrating a configuration of a quality inspection system in accordance with the present disclosure.

FIG. 2 is a flowchart illustrating a flow of a quality inspection method in accordance with the present disclosure.

FIG. 3 is a block diagram illustrating a configuration of a quality inspection apparatus in accordance with the present disclosure.

FIG. 4 is a flowchart illustrating a flow of a quality inspection method in accordance with the present disclosure.

FIG. 5 is a view illustrating an example of an inspection system that uses a quality inspection system in accordance with the present disclosure.

FIG. 6 is a view illustrating an example of an image displayed on an input terminal in accordance with the present disclosure.

FIG. 7 is a view illustrating examples of images captured of a wall material in the present disclosure.

FIG. 8 is a view illustrating an example of an image displayed on an output terminal in accordance with the present disclosure.

FIG. 9 is a view illustrating another example of the image displayed on the output terminal in accordance with the present disclosure.

FIG. 10 is a view illustrating still another example of the image displayed on the output terminal in accordance with the present disclosure.

FIG. 11 is a view illustrating yet another example of the image displayed on the output terminal in accordance with the present disclosure.

FIG. 12 is a block diagram illustrating a configuration of a quality inspection system in accordance with the present disclosure.

FIG. 13 is a flowchart illustrating a flow of a quality inspection method in accordance with the present disclosure.

FIG. 14 is a view illustrating an example of processing performed by a preprocessing unit in accordance with the present disclosure.

FIG. 15 is a view illustrating another example of the processing performed by the preprocessing unit in accordance with the present disclosure.

FIG. 16 is a view illustrating still another example of the processing performed by the preprocessing unit in accordance with the present disclosure.

FIG. 17 is a view illustrating an example of processing performed by a division unit in accordance with the present disclosure.

FIG. 18 is a view illustrating another example of the processing performed by the division unit in accordance with the present disclosure.

FIG. 19 is a block diagram illustrating a configuration of a quality inspection apparatus in accordance with the present disclosure.

FIG. 20 is a block diagram illustrating an example of a hardware configuration of a quality inspection system, a quality inspection apparatus, an AP/DB server, and a determination server in accordance with the present disclosure.

### DESCRIPTION OF EMBODIMENTS

The example embodiments of the present invention will be exemplified in the following description. It should be noted that the present invention is not limited to the example embodiments described below, but may be altered in various ways by a skilled person within the scope of the claims. For example, any example embodiment derived by appropriately combining technical means employed in the example embodiments described below can also be within the scope of the present invention. Further, any example embodiment derived from appropriately omitting some of the technical means employed in the example embodiments described below can also be within the scope of the present invention. Furthermore, an example advantage to which reference is made in each of the example embodiments described below is an example of the advantage expected in that example embodiment, and does not define the extension of the present invention. Therefore, any example embodiment which does not provide the example advantage to which reference is made in each of the example embodiments described below can also be within the scope of the present invention.

### First Example Embodiment

A first example embodiment which is an example of an embodiment of the present invention will be described in detail with reference to the drawings. The present example embodiment is a basic form of each example embodiment described later. The scope of the application of each technical means employed in the present example embodiment is not limited to the present example embodiment. That is, each technical means employed in the present example embodiment can also be employed in other example embodiments included in the present disclosure to the extent that no particular technical obstruction occurs. In addition, each technical means illustrated in the drawings which are referred to for the description of the present example embodiment can also be employed in other example embodiments included in the present t disclosure to the extent that no particular technical obstruction occurs.

### (Configuration of Quality Inspection System 1)

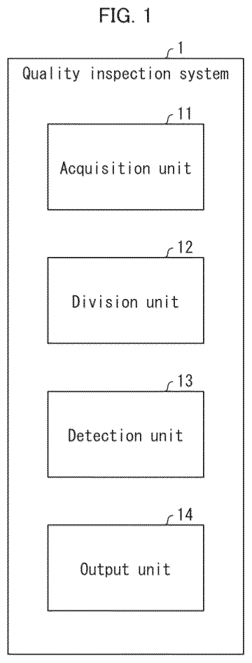

A configuration of a quality inspection system 1 will be described with reference to FIG. 1. FIG. 1 is a block diagram illustrating the configuration of the quality inspection system 1. The quality inspection system 1 includes an acquisition unit 11, a division unit 12, a detection unit 13, and an output unit 14, as illustrated in FIG. 1. The acquisition unit 11, the division unit 12, the detection unit 13, and the output unit 14 realize an acquisition means, a division means, a detection means, and an output means, respectively, in the present example embodiment.

The acquisition unit 11 acquires an image captured of a wall material. The acquisition unit 11 supplies the acquired image to the division unit 12.

The division unit 12 divides the image acquired by the acquisition unit 11 into a plurality of small images. The division unit 12 supplies, to the detection unit 13, the plurality of small images obtained by the division.

The detection unit 13 detects a defect included in the wall material by referring to a combination of at least two determination results which have been obtained by inputting the small images, which have been obtained by the division carried out by the division unit 12, into each of at least two machine learning models that have been trained by different training methods and that each use, as input, an image captured of a wall material and output a determination result which is obtained by determining whether or not the wall material is defective. The detection unit 13 supplies a detection result to the output unit 14.

The output unit 14 outputs the detection result obtained by the detection unit 13.

(Effect Brought about by Quality Inspection System 1)

As described above, the quality inspection system 1 employs a configuration in which the quality inspection system 1 includes: the acquisition unit 11 that acquires an image captured of a wall material; the division unit 12 that divides the image acquired by the acquisition unit 11 into a plurality of small images; the detection unit 13 that detects a defect included in the wall material by referring to a combination of at least two determination results which have been obtained by inputting the small images, which have been obtained by the division carried out by the division unit 12, into each of at least two machine learning models that have been trained by different training methods and that each use, as input, an image captured of a wall material and output a determination result which is obtained by determining whether or not the wall material is defective; and the output unit 14 that outputs a detection result which is obtained by the detection unit 13.

Thus, according to the quality inspection system 1, the effect of enabling an improvement in the accuracy of detecting a defect in a wall material is obtained.

### (Flow of Quality Inspection Method S1)

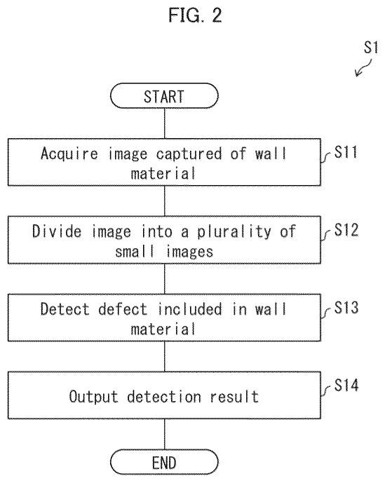

A flow of a quality inspection method S1 will be described with reference to FIG. 2. FIG. 2 is a flowchart illustrating the flow of the quality inspection method S1. The quality inspection method S1 includes an acquisition process S11, a division process S12, a detection process S13, and an output process S14, as illustrated in FIG. 2.

### (Acquisition Process S11)

In the acquisition process S11, the acquisition unit 11 acquires an image captured of a wall material. The acquisition unit 11 supplies the acquired image to the division unit 12.

### (Division Process S12)

In the division process S12, the division unit 12 divides the image acquired by the acquisition unit 11 into a plurality of small images. The division unit 12 supplies, to the detection unit 13, the plurality of small images obtained by the division.

### (Detection Process S13)

In the detection process S13, the detection unit 13 detects a defect included in the wall material by referring to a combination of at least two determination results which have been obtained by inputting the small images, which have been obtained by the division carried out by the division unit 12, into each of at least two machine learning models that have been trained by different training methods and that each use, as input, an image captured of a wall material and output a determination result which is obtained by determining whether or not the wall material is defective. The detection unit 13 supplies a detection result to the output unit 14.

### (Output Process S14)

In the output process S14, the output unit 14 outputs the detection result obtained by the detection unit 13.

(Effect Brought about by Quality Inspection Method S1)

As described above, in the quality inspection method S1, a configuration is employed in which the quality inspection method S1 includes: the acquisition process S11 in which the acquisition unit 11 acquires an image captured of a wall material; the division process S12 in which the division unit 12 divides the image acquired by the acquisition unit 11 into a plurality of small images; the detection process S13 in which the detection unit 13 detects a defect included in the wall material by referring to a combination of at least two determination results which have been obtained by inputting the small images, which have been obtained by the division carried out by the division unit 12, into each of at least two machine learning models that have been trained by different training methods and that each use, as input, an image captured of a wall material and output a determination result which is obtained by determining whether or not the wall material is defective; and the output process S14 in which the output unit 14 outputs a detection result which is obtained by the detection unit 13. Thus, according to the quality inspection method S1, an effect similar to the effect brought about by the above-described quality inspection system 1 is obtained.

### (Configuration of Quality Inspection Apparatus 2)

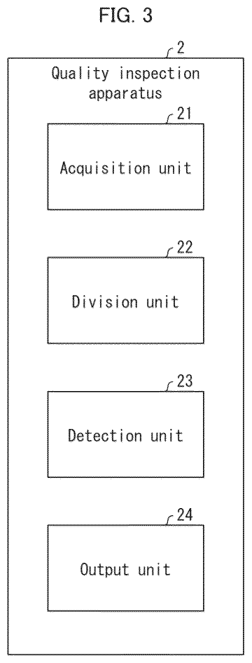

A configuration of a quality inspection apparatus 2 will be described with reference to FIG. 3. FIG. 3 is a block diagram illustrating the configuration of the quality inspection apparatus 2. The quality inspection apparatus 2 includes an acquisition unit 21, a division unit 22, a detection unit 23, and an output unit 24, as illustrated in FIG. 3. The acquisition unit 21, the division unit 22, the detection unit 23, and the output unit 24 realize the acquisition means, the division means, the detection means, and the output means, respectively, in the present example embodiment.

The acquisition unit 21 acquires an image captured of a wall material. The acquisition unit 21 supplies the acquired image to the division unit 22.

The division unit 22 divides the image acquired by the acquisition unit 21 into a plurality of small images. The division unit 22 supplies, to the detection unit 23, the plurality of small images obtained by the division.

The detection unit 23 detects a defect included in the wall material by referring to a combination of at least two determination results which have been obtained by inputting the small images, which have been obtained by the division carried out by the division unit 22, into each of at least two machine learning models that have been trained by different training methods and that each use, as input, an image captured of a wall material and output a determination result which is obtained by determining whether or not the wall material is defective. The detection unit 23 supplies a detection result to the output unit 24.

The output unit 24 outputs the detection result obtained by the detection unit 23.

(Effect Brought about by Quality Inspection Apparatus 2)

As described above, the quality inspection apparatus 2 employs a configuration in which the quality inspection apparatus 2 includes: the acquisition unit 21 that acquires an image captured of a wall material; the division unit 22 that divides the image acquired by the acquisition unit 21 into a plurality of small images; the detection unit 23 that detects a defect included in the wall material by referring to a combination of at least two determination results which have been obtained by inputting the small images, which have been obtained by the division carried out by the division unit 22, into each of at least two machine learning models that have been trained by different training methods and that each use, as input, an image captured of a wall material and output a determination result which is obtained by determining whether or not the wall material is defective; and the output unit 24 that outputs a detection result which is obtained by the detection unit 23. Thus, according to the quality inspection apparatus 2, an effect similar to the effect brought about by the above-described quality inspection system 1 is obtained.

### (Flow of Quality Inspection Method S2)

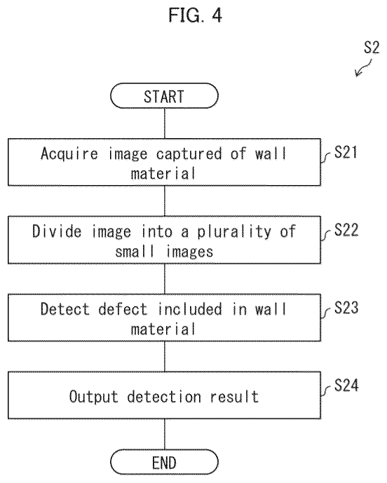

A flow of a quality inspection method S2 will be described with reference to FIG. 4. FIG. 4 is a flowchart illustrating the flow of the quality inspection method S2. The quality inspection method S2 includes an acquisition process S21, a division process S22, a detection process S23, and an output process S24, as illustrated in FIG. 4.

### (Acquisition Process S21)

In the acquisition process S21, the acquisition unit 21 acquires an image captured of a wall material. The acquisition unit 21 supplies the acquired image to the division unit 22.

### (Division Process S22)

In the division process S22, the division unit 22 divides the image acquired by the acquisition unit 21 into a plurality of small images. The division unit 22 supplies, to the detection unit 23, the plurality of small images obtained by the division.

### (Detection Process S23)

In the detection process S23, the detection unit 23 detects a defect included in the wall material by referring to a combination of at least two determination results which have been obtained by inputting the small images, which have been obtained by the division carried out by the division unit 22, into each of at least two machine learning models that have been trained by different training methods and that each use, as input, an image captured of a wall material and output a determination result which is obtained by determining whether or not the wall material is defective. The detection unit 23 supplies a detection result to the output unit 24.

### (Output Process S24)

In the output process S24, the output unit 24 outputs the detection result obtained by the detection unit 23.

(Effect Brought about by Quality Inspection Method S2)

As described above, in the quality inspection method S2, a configuration is employed in which the quality inspection method S2 includes: the acquisition process S21 in which the acquisition unit 21 acquires an image captured of a wall material; the division process S22 in which the division unit 22 divides the image acquired by the acquisition unit 21 into a plurality of small images; the detection process S23 in which the detection unit 23 detects a defect included in the wall material by referring to a combination of at least two determination results which have been obtained by inputting the small images, which have been obtained by the division carried out by the division unit 22, into each of at least two machine learning models that have been trained by different training methods and that each use, as input, an image captured of a wall material and output a determination result which is obtained by determining whether or not the wall material is defective; and the output process S24 in which the output unit 24 outputs a detection result which is obtained by the detection unit 23. Thus, according to the quality inspection method S2, an effect similar to the effect brought about by the above-described quality inspection system 1 is obtained.

### Second Example Embodiment

A Second Example Embodiment which is an Example of an embodiment of the present invention will be described in detail with reference to the drawings. The same reference numerals are given to constituent elements which have functions identical with those described in the above-described example embodiment, and descriptions as to such constituent elements are omitted as appropriate. The scope of the application of the technical means employed in the present example embodiment is not limited to the present example embodiment. That is, each technical means employed in the present example embodiment can also be employed in other example embodiments included in the present disclosure to the extent that no particular technical obstruction occurs. In addition, each technical means illustrated in the drawings which are referred to for the description of the present example embodiment can also be employed in other example embodiments included in the present disclosure to the extent that no particular technical obstruction occurs.

### (Outline of Quality Inspection System 1A)

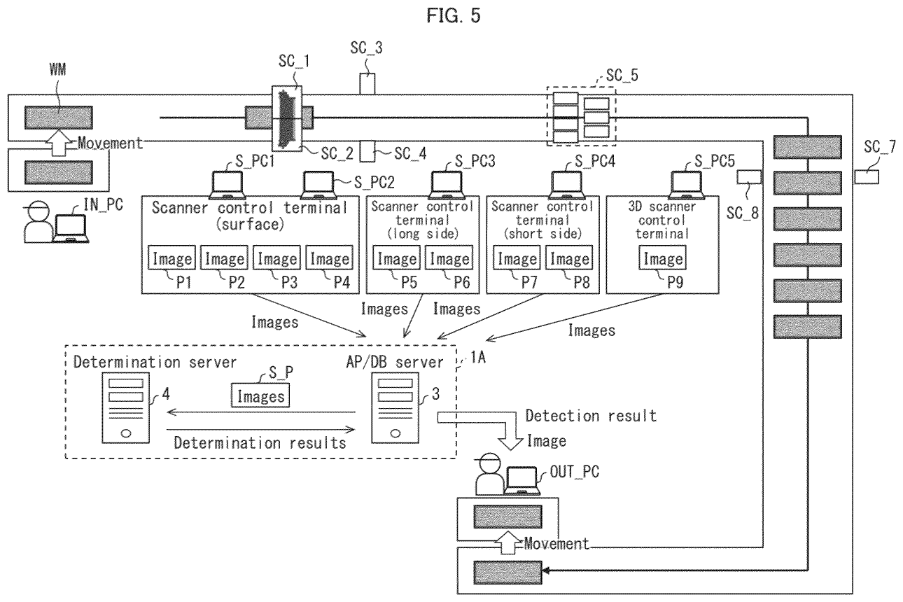

An outline of a quality inspection system 1A will be described with reference to FIG. 5. FIG. 5 is a view illustrating an example of an inspection system that uses the quality inspection system 1A. In the inspection system illustrated in FIG. 5, an input terminal IN_PC, an output terminal OUT_PC, a scanner control terminals S_PC1 to S_PC5, and the quality inspection system 1A are communicably connected to each other.

The quality inspection system 1A is a system for detecting a defect included in a wall material WM with use of an image captured of the wall material WM. The quality inspection system 1A detects a defect included in the wall material WM with use of at least two machine learning models which will be described later. The quality inspection system 1A also includes a configuration in which the at least two machine learning models are trained.

As illustrated in FIG. 5, the quality inspection system 1A is configured to include an application (AP)/database (DB) server 3 and a determination server 4.

In FIG. 5, the AP/DB server 3 acquires images P1 to P9 captured of the wall material WM from the scanner control terminals S_PC1 to S_PC5. The AP/DB server 3 processes and divides the acquired images P1 to P9 to generate a plurality of images S_P (small images) which are targets for determination. The AP/DB server 3 requests the determination server 4 to determine whether or not the wall material WM is defective by outputting the plurality of images S_P to the determination server 4.

Further, the AP/DB server 3 acquires at least two determination results output from the determination server 4. The AP/DB server 3 detects the defect included in the wall material WM by referring to a combination of the at least two determination results output from the determination Server 4. The combination of the determination results to be referred to by the AP/DB server 3 will be described later.

Further, the AP/DB server 3 outputs a detection result to the output terminal OUT_PC. The AP/DB server 3 may output, to the output terminal OUT_PC, an image in which a defective part is shown, in addition to the detection result.

Note that the “image in which a defective part is shown” output by the AP/DB server 3 is an image in which a part that has been determined to be defective by a machine learning model is shown. In other words, there are a case where, by an operator or a user of a wall material who checks the “image in which a defective part is shown” output by the AP/DB server 3, it is finally determined that the wall material is defective and a case where, by an operator or a user of a wall material who checks the “image in which a defective part is shown” output by the AP/DB server 3, it is finally determined that the wall material is not defective.

The determination server 4 acquires the plurality of images S_P output from the AP/DB server 3. The determination server 4 acquires at least two determination results by inputting, into at least two machine learning models, each of the plurality of images S_P thus acquired. The determination server 4 outputs the at least two determination results thus acquired to the AP/DB server 3.

### (Flow 1 of Inspection System)

An example of the flow of the inspection system illustrated in FIG. 5 will be described.

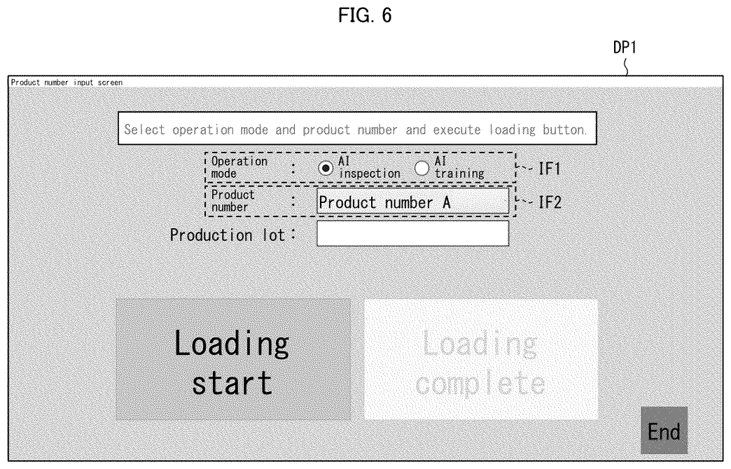

As illustrated in an upper left part of FIG. 5, in order to capture an image of a wall material WM which is a target for defect detection, an operator moves the wall material WM onto a conveyor. Here, the operator inputs, into the input terminal IN_PC, whether to detect a defect included in the wall material WM or to train at least two machine learning models. FIG. 6 illustrates an example of an image displayed on the input terminal IN_PC.

FIG. 6 is a view illustrating the example of the image displayed on the input terminal IN_PC. An image DP1 illustrated in FIG. 6 includes an interface IF1 for selecting whether to detect a defect included in the wall material WM (“AI inspection” in FIG. 6) or to train the at least two machine learning models (“AI training” in FIG. 6). Further, the image DP1 includes an interface IF2 for inputting a product number of the wall material WM. The following will describe a flow in a case where the operator has selected the “AI inspection”.

The wall material WM moved onto the conveyor is subjected to image capture of an upper surface of the wall material WM by scanners SC_1 and SC_2. Hereinafter, a 2D scanner will be referred to simply as “scanner”. Similarly, with regard to an image, a 2D image will be referred to simply as “image”. The scanners SC_1 and the scanner SC_2 each include two image capture apparatuses. The scanner SC_1 and the scanner SC_2 supply captured images to the scanner control terminal S_PC1 and the scanner control terminal S_PC2, respectively. The scanner control terminal S_PC1 and the scanner control terminal S_PC2 output the captured images P1 to P4 to the AP/DB server 3.

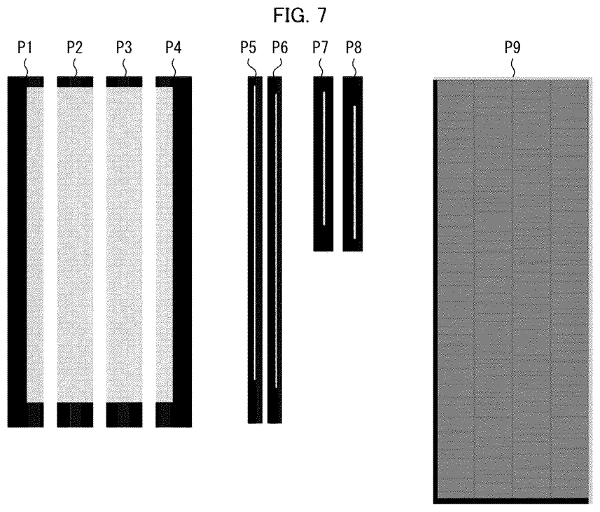

Examples of the images P1 to P4 are illustrated in FIG. 7. FIG. 7 is a view illustrating examples of images captured of the wall material WM.

As described above, the scanner SC_1 and the scanner SC_2 each include two image capture apparatuses. Thus, the scanner SC_1 and the scanner SC_2 output the four images P1 to P4 illustrated in FIG. 7 to the AP/DB server 3. The Images P1 and P2 are images, captured by the scanner SC_1, of an area on the left side of the wall material WM from the center thereof along the longitudinal direction of the wall material WM. Further, the images P3 and P4 are images, captured by the scanner SC_2, of an area on the right side of the wall material WM from the center thereof along the longitudinal direction of the wall material WM.

Next, the wall material WM is subjected to image capture of long-side lateral surfaces of the wall material WM in a top view thereof by scanners SC_3 and SC_4. The scanner SC_3 and the scanner SC_4 each supply captured images to the scanner control terminal S_PC3. The scanner control terminal S_PC3 outputs the captured images P5 and P6 to the AP/DB server 3. Examples of the images P5 and P6 are illustrated in FIG. 7. The image P5 is an image captured by the scanner SC_3 from the left in the traveling direction of the conveyor. The image P6 is an image captured by the scanner SC_4 from the right in the traveling direction of the conveyor.

Subsequently, the wall material WM is subjected to image capture by a 3D scanner SC_5 that is constituted by a plurality of scanners. The 3D scanner SC_5 supplies captured images to a 3D scanner control terminal S_PC5. The 3D scanner control terminal S_PC5 generates a three-dimensional image P9 of the wall material WM which has been formed on the basis of the captured images. The 3D scanner control terminal S_PC5 outputs the image P9 to the AP/DB server 3. An example of the image P9 is illustrated in FIG. 7.

Further, the wall material WM is subjected to image capture of short-side lateral surfaces of the wall material WM in a top view thereof by scanners SC_7 and SC_8. The scanner SC_7 and the scanner SC_8 each supply captured images to the scanner control terminal S_PC4. The scanner control terminal S_PC4 outputs the captured images P7 and P8 to the AP/DB server 3. Examples of the images P7 and P8 are illustrated in FIG. 7. The image P7 is an image captured by the scanner SC_7 from the left in the traveling direction of the conveyor. The image P8 is an image captured by the scanner SC_8 from the right in the traveling direction of the conveyor.

After having acquired the images P1 to P9, the AP/DB server 3 processes and divides the images P1 to P9 to generate a plurality of images S_P which are targets for determination. An example of a process in which the AP/DB server 3 processes and divides images will be described later. The AP/DB server 3 outputs, to the determination server 4, the plurality of images S_P thus generated.

The determination server 4 acquires at least two determination results by inputting, into at least two machine learning models, each of the plurality of images S_P output from the AP/DB server 3. The determination server 4 outputs the at least two determination results thus acquired to the AP/DB server 3.

The AP/DB server 3 acquires at least two determination results output: from the determination server 4. The AP/DB server 3 detects the defect included in the wall material WM by referring to a combination of the at least two determination results output from the determination server 4. The AP/DB server 3 outputs a detection result to the output terminal OUT_PC.

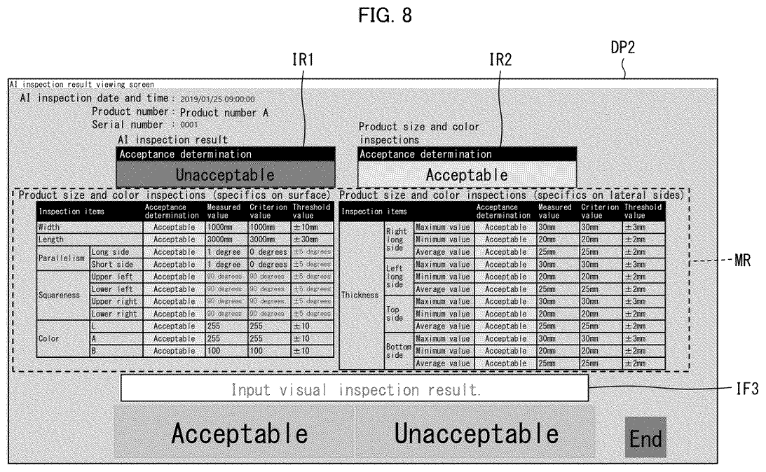

The output terminal OUT_PC outputs the detection result output from the AP/DB server 3. Examples of an image displayed on the output terminal OUT_PC are illustrated in FIGS. 8 to 11.

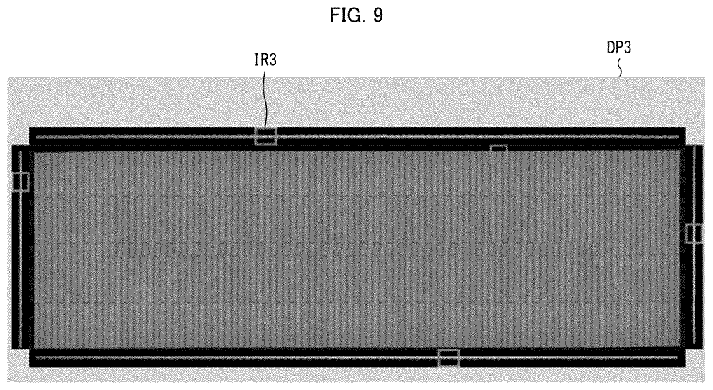

FIG. 8 is a view illustrating an example of the image displayed on the output terminal OUT_PC. An image DP2 illustrated in FIG. 8 includes a detection result IR1 output from the AP/DB server 3. In a case where the output terminal OUT_PC has acquired, in addition to the detection result, an image in which a defective part is shown, the output terminal OUT_PC may display the image in which a defective part is shown. An example of the image in which a defective part is shown is illustrated in FIG. 9.

FIG. 9 is a view illustrating another example of the image displayed on the output terminal OUT_PC. An image DP3 illustrated in FIG. 9 is an image which includes the entire wall material WM as a subject. The image DP3 further includes a detection result IR3 indicating that a defective part is included in a square frame.

Further, the detection result output from the AP/DB server 3 may include at least one selected from the group consisting of information pertaining to an outer dimension (e.g., width, length, parallelism, squareness, and thickness) of the wall material WM and information pertaining to a color of the wall material WM. As an example, the detection result may include, as the information pertaining to an outer dimension of the wall material WM, information indicating whether or not the outer dimension of the wall material WM falls within a threshold range. As another example, the detection result may include information indicating whether or not a value of a pixel value of the wall material WM in the image falls within a threshold range.

In a case where the detection result includes the information indicating whether or not the outer dimension of the wall material WM falls within the threshold range and the information indicating whether or not the value of the pixel value of the wall material WM in the image falls within the threshold range, the image DP2 may include a result IR2 that is indicated by these pieces of information. The image DP2 may further include an item MR that indicates the outer dimension of the wall material WM and the pixel value of the wall material WM in the image.

In this way, the quality inspection system 1A causes the detection result to include at least one selected from the group consisting of the information indicating whether or not the outer dimension of the wall material WM falls within the threshold range and the information indicating whether or not the value of the pixel value of the wall material WM falls within a threshold range. Thus, the quality inspection system 1A makes it possible to detect and present a defect other than defects such as a scratch and a dent.

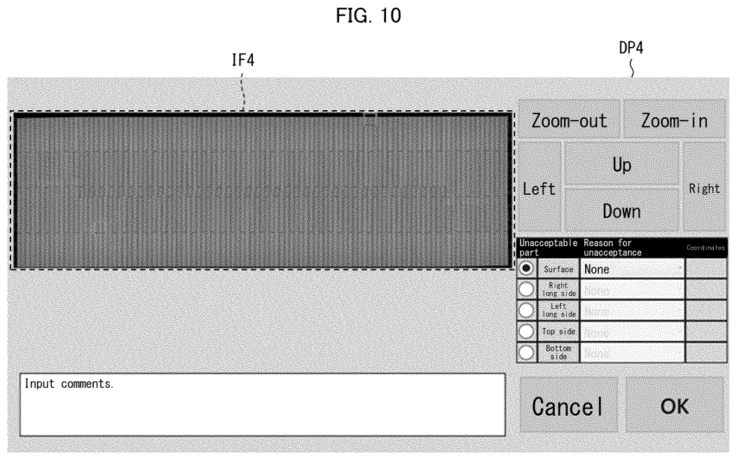

In addition, the image DP2 may include an interface IF3 for inputting a visual inspection result obtained by the operator. An example of an image displayed on the output terminal OUT_PC in a case where the operator has selected the interface IF3 for inputting a visual inspection result is illustrated in FIG. 10.

FIG. 10 is a view illustrating still another example of the image displayed on the output terminal OUT_PC. An image DP4 illustrated in FIG. 10 includes an interface IF4 for inputting a defective part. The operator inputs the defective part into the image of the wall material WM which is the interface IF4.

### (Flow 2 of Inspection System)

Another example of the flow of the inspection system illustrated in FIG. 5 will be described. The following will describe a flow in a case where the operator has selected the “AI training” in the input terminal IN_PC.

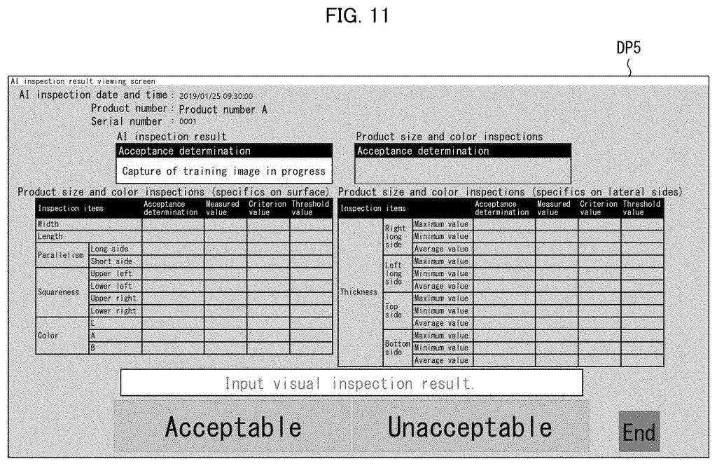

Also in such a configuration, the AP/DB server 3 acquires the images P1 to P9 by the above-described method. An example of an image displayed on the output terminal OUT_PC while the images P1 to P9 are being captured is illustrated in FIG. 11.

FIG. 11 is a view illustrating yet another example of the image displayed on the output terminal OUT_PC. The image DP5 illustrated in FIG. 11 includes a text indicating that capture of a training image is in progress.

Upon completion of the image capture of the wall material WM, the output terminal OUT_PC displays the above-described image DP2. In a case where “acceptable” has been input as the inspection result in the image DP2 (that is, in a case where the operator has determined that the wall material WM is not defective), the AP/DB server 3 generates, as training data, a set of the captured images P1 to P9 (small images obtained by processing and dividing each of the images P1 to P9) and a determination result indicating that the wall material WM included as a subject in the images P1 to P9 is not defective (normal). The AP/DB server 3 outputs, to the determination server 4, the training data thus generated. The determination server 4 trains machine learning models by machine learning with use of the training data output from the AP/DB server 3.

On the other hand, in a case where “unacceptable” has been input as the inspection result in the image DP2 (that is, in a case where the operator has determined that the wall material WM is defective), the output terminal OUT_PC displays an image DP4. The output terminal OUT_PC outputs, to the AP/DB server 3, information indicating input to the interface IF4 for inputting a defective part (input indicating which part of the wall material WM includes a defect).

On the basis of the information output from the output terminal OUT_PC, the AP/DB server 3 generates, as training data, a set of images that are small images obtained by dividing the captured images P1 to P9 and that include a part where a defect indicated by the information is included and a determination result indicating that the wall material WM included as a subject in the images is defective. The AP/DB server 3 outputs, to the determination server 4, the training data thus generated. The determination server 4 trains machine learning models by machine learning with use of the training data output from the AP/DB server 3. An example of a configuration in which the machine learning models are trained by machine learning will be described later.

Note that the training data may be generated on the basis of a result of a determination made by a customer (a manufacturer who manufactures a wall material) on whether or not the wall material is defective. That is, a set of an image and a determination result indicating that a wall material in the image has been determined not to be defective by the customer and a set of an image and a determination result indicating that a wall material in the image has been determined to be defective by the customer may be used as training data.

### (Configuration of Quality Inspection System 1A)

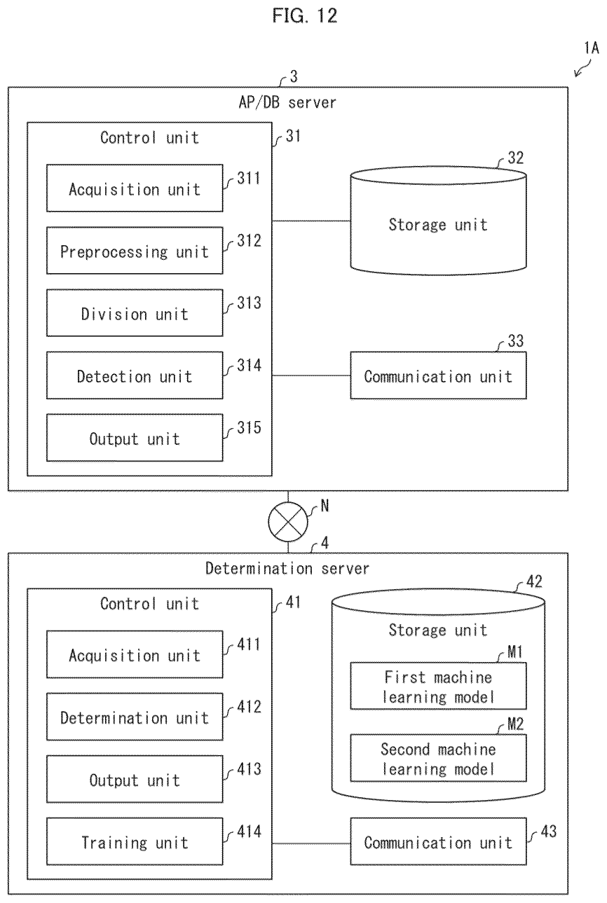

A configuration of the quality inspection system 1A will be described with reference to FIG. 12. FIG. 12 is a block diagram illustrating the configuration of the quality inspection system 1A. As described above, the quality inspection system 1A is configured to include the AP/DB server 3 and the determination server 4.

The AP/DB server 3 and the determination server 4 are communicably connected to each other via a network N. A specific configuration of the network N is not intended to limit the present example embodiment. As an example of the network N, a wireless local area network (LAN) and a wired LAN can be taken. As another example of the network N, it is possible to employ a wide area network (WAN), a public network, a mobile data communication network, or a combination of these networks.

### (Configuration of AP/DB Server 3)

The AP/DB server 3 includes a control unit 31, a storage unit 32, and a communication unit 33, as illustrated in FIG. 12.

The storage unit 32 stores data to be referred to by the control unit 31. Examples of the data stored in the storage unit 32 include an image captured of a wall material WM. Examples of the storage unit 32 include, but not limited to, a flash memory, a hard disk drive (HDD), a solid state drive (SSD), and a combination of these.

The communication unit 33 is an interface that transmits and receives data via a network. As an example, the communication unit 33 transmits, to the determination server 4, data supplied from the control unit 31 and supplies, to the control unit 31, data received from the determination server 4. Examples of the communication unit 33 include, but not limited to, a communication chip in various communication standards such as Ethernet (registered trademark), Wi-Fi (registered trademark), and radio communications standard for mobile data communications networks, and a USB-compliant connector.

### (Control Unit 31)

The control unit 31 controls constituent elements included in the AP/DB server 3.

Further, the control unit 31 includes an acquisition unit 311, a preprocessing unit 312, a division unit 313, a detection unit 314, and an output unit 315, as illustrated in FIG. 12. The acquisition unit 311, the preprocessing unit 312, the division unit 313, the detection unit 314, and the output unit 315 realize an acquisition means, a preprocessing means, a division means, a detection means, and an output means, respectively, in the present example embodiment.

The acquisition unit 311 acquires data. As an example, the acquisition unit 311 acquires an image captured of a wall material WM (for example, the above-described images P1 to P9). As another example, the acquisition unit 311 acquires at least two determination results. The acquisition unit 311 stores the acquired data in the storage unit 32.

The preprocessing unit 312 processes an image before division (carries out preprocessing on an image to be divided). As an example, the preprocessing unit 312 processes the image acquired by the acquisition unit 311. For example, the preprocessing unit 312 carries out at least one selected from the group consisting of connection between images, inclination correction of the wall material WM in an image, alignment of the wall material WM in an image, color processing, and edge processing. The preprocessing unit 312 stores the processed data in the storage unit 32. Examples of the process carried out by the preprocessing unit 312 will be described later.

The division unit 313 divides an image into a plurality of small images. As an example, the division unit 313 divides, into a plurality of small images, the image that is stored in the storage unit 32 and that has been processed by the preprocessing unit 312. The division unit 313 stores, in the storage unit 32, the plurality of small images obtained by the division. Examples of the process carried out by the division unit 313 will be described later.

The detection unit 314 detects a defect included in the wall material WM. As an example, the detection unit 314 detects a defect included in the wall material WM by referring to a combination of at least two determination results output from the determination server 4. The detection unit 314 stores a detection result in the storage unit 32.

In addition, the detection unit 314 changes, in accordance with the type of the wall material WM, the combination of the at least two determination results to be referred to. As an example, the detection unit 314 detects a defect included in the wall material WM by performing logical operations on the at least two determination results. In this case, the detection unit 314 may change, in accordance with the type of the wall material WM, the logical operations to be performed on the at least two determination results. Examples of the process carried out by the detection unit 314 will be described later.

In addition, the detection unit 314 may measure the outer dimension of the wall material WM and the color of the wall material WM. In this case, the detection unit 314 may cause the detection result to include information pertaining to the outer dimension of the wall material WM and information pertaining to the color of the wall material WM.

The output unit 315 outputs data. As an example, the output unit 315 outputs the detection result stored in the storage unit 32. As another example, the output unit 315 outputs, in addition to the detection result, an image in which a defective part is shown. As still another example, the output unit 315 outputs, to the determination server 4, the plurality of small images (for example, the above-described images S_P), which have been obtained by the division carried out by the division unit 313, as images targeted for the determination.

In addition, the output unit 315 generates training data to be used for machine learning of a first machine learning model M1 and a second machine learning model M2, which will be described later, and outputs the training data. An example of a method of the output unit 315 generating the training data is as described above.

### (Configuration of Determination Server 4)

The determination server 4 includes a control unit 41, a storage unit 42, and a communication unit 43, as illustrated in FIG. 12.

The storage unit 42 stores data to be referred to by the control unit 41. Included as an example of the data stored in the storage unit 42 are the first machine learning model M1 and the second machine learning model M2, which will be described later. In this case, the storage unit 42 may store respective parameters defining the first machine learning model M1 and the second machine learning model M2. Included as another example of the data stored in the storage unit 42 are images targeted for the determination. Examples of the storage unit 42 include, but not limited to, a flash memory, an HDD, an SSD, and a combination of these.

The communication unit 43 is an interface that transmits and receives data via a network. As an example, the communication unit 43 transmits, to the AP/DB server 3, data supplied from the control unit 41 and supplies, to the control unit 41, data received from the AP/DB server 3. Examples of the communication unit 43 include, but not limited to, a communication chip in various communication standards such as Ethernet, Wi-Fi, and radio communications standard for mobile data communications networks, and a USB-compliant connector.

### (Control Unit 41)

The control unit 41 controls constituent elements included in the determination server 4.

Further, the control unit 41 includes an acquisition unit 411, a determination unit 412, an output unit 413, and a training unit 414, as illustrated in FIG. 12. The training unit 414 realizes a training means in the present example embodiment.

The acquisition unit 411 acquires data. As an example, the acquisition unit 411 acquires a plurality of small images obtained by division. As another example, the acquisition unit 411 acquires training data. The acquisition unit 411 stores the acquired data in the storage unit 42.

The determination unit 412 determines whether or not the wall material WM is defective. As an example, the determination unit 412 carries out the determination by inputting the plurality of images which are stored in the storage unit 42 into each of at least two machine learning models that have been trained by different training methods and that each use, as input, an image captured of a wall material WM (e.g., the above-described image S_P) and output a determination result which is obtained by determining whether or not the wall material WM is defective. The determination unit 412 stores, in the storage unit 42, at least two determination results output from the at least two machine learning models.

The at least two machine learning models that have been trained by different training methods include at least one first machine learning model M1 and at least one second machine learning model M2.

The first machine learning model M1 is a machine learning model that has been trained by machine learning with use of, as training data, a set of an image of a normal wall material WM which includes no defect and a determination result indicating that the wall material WM is normal. Hereinafter, the first machine learning model will also be referred to as one-class model.

The second machine learning model M2 is a machine learning model that has been trained by machine learning with use of, as training data, a set of an image of a normal wall material WM and a determination result indicating that the wall material WM is normal and a set of an image of a defective wall material WM and a determination result indicating that the wall material WM is defective. The second machine learning model M2 will also be referred to as multi-class model. Examples of the first machine learning model and the second machine learning model will be described later.

The output unit 413 outputs data. As an example, the output unit 413 outputs at least two determination results stored in the storage unit 42.

The training unit 414 trains the first machine learning model M1 and the second machine learning model M2. As an example, the training unit 414 trains the first machine learning model M1 and the second machine learning model M2 with use of training data output from the AP/DB server 3.

Specifically, as described above, the training unit 414 trains the first machine learning model M1 with use of, as training data, a set of an image of a normal wall material WM which includes no defect and a determination result indicating that the wall material WM is normal.

Further, the training unit 414 trains the second machine learning model M2 with use of, as training data, a set of an image of a normal wall material WM and a determination result indicating that the wall material WM is normal and a set of an image of a defective wall material WM and a determination result indicating that the wall material WM is defective.

With this configuration, the training unit 414 can suitably train the first machine learning model M1 and the second machine learning model M2.

### (Flow of Quality Inspection Method S1A)

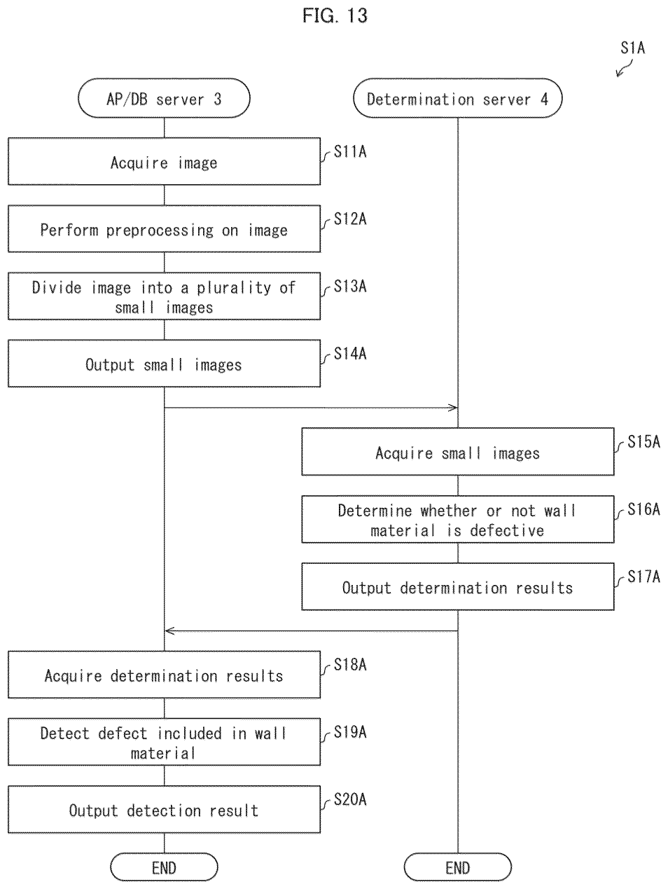

A flow of a quality inspection method S1A carried out by the quality inspection system 1A will be described with reference to FIG. 13. FIG. 13 is a flowchart illustrating the flow of the quality inspection method S1A.

### (Step S11A)

In step S11A, the acquisition unit 311 of the AP/DB server 3 acquires an image captured of a wall material WM. The acquisition unit 311 of the AP/DB server 3 stores the acquired image in the storage unit 32.

### (Step S12A)

In step S12A, the preprocessing unit 312 performs preprocessing on the image stored in the storage unit 32. The preprocessing unit 312 stores, in the storage unit 32, the image on which the preprocessing has been performed.

### (Step S13A)

In step S13A, the division unit 313 divides, into a plurality of small images, the image that is stored in the storage unit 32 and that has been processed by the preprocessing unit 312. The division unit 313 stores, in the storage unit 32, the plurality of small images obtained by the division.

### (Step S14A)

In step S14A, the output unit 315 outputs, to the determination server 4, the plurality of small images that have been obtained by the division and that are stored in the storage unit 32.

### (Step S15A)

In step S15A, the acquisition unit 411 of the determination server 4 acquires the plurality of small images output from the AP/DB server 3. The acquisition unit 411 stores, in the storage unit 42, the plurality of small images thus acquired.

### (Step S16A)

In step S16A, the determination unit 412 acquires at least two determination results by inputting the plurality of small images which are stored in the storage unit 42 into each of the at least one first machine learning model M1 and the at least one second machine learning model M2, and determines whether or not the wall material WM is defective. The determination unit 412 stores, in the storage unit 42, the at least two determination results.

### (Step S17A)

In step S17, the output unit 413 outputs, to the AP/DB server 3, the at least two determination results stored in the storage unit 42.

### (Step S18A)

In step S18A, the acquisition unit 311 of the AP/DB server 3 acquires the at least two determination results output from the determination server 4. The acquisition unit 311 stores the acquired at least two determination results in the storage unit 32.

### (Step S19A)

In step S19A, the detection unit 314 detects a defect included in the wall material WM by referring to a combination of the at least two determination results stored in the storage unit 32. The detection unit 314 stores a detection result in the storage unit 32.

### (Step S20A)

In step S20A, the output unit 315 outputs the detection result stored in the storage unit 32.

### (Example 1 of Processing Performed by Preprocessing Unit 312)

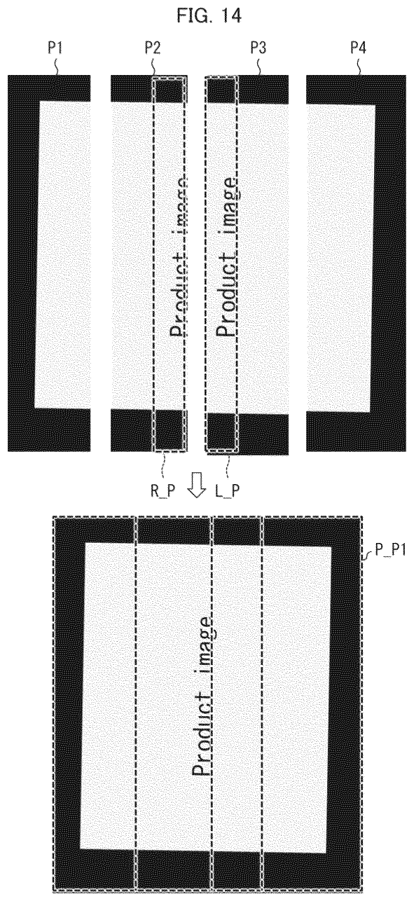

An example of the processing performed by the preprocessing unit 312 will be described with reference to FIG. 14. FIG. 14 is a view illustrating an example of the processing performed by the preprocessing unit 312.

The following description will take, as an example, a case where an upper surface of a wall material WM is subjected to image capture by the scanner SC_1 and the scanner SC_2 each of which includes two image capture apparatuses, as in the above-described inspection system in FIG. 5.

In this case, in step S11A, the acquisition unit 311 acquires images P1 to P4 in FIG. 14. Note that, on the surface of the wall material WM included as a subject in the images P1 to P4 acquired by the acquisition unit 311, the words “product image” are printed for the sake of making the preprocessing easy to understand.

The preprocessing unit 312 generates an image P_P1 which includes the entire wall material WM by connecting the images P1 to P4 in FIG. 14. Here, the images P1 to P4 include regions that overlap each other (e.g., a region R_P of the image P2 and a region L_P of the image P3). Therefore, the preprocessing unit 312 connects the images P1 to P4 in such a manner as to eliminate redundancy of the regions R_P and L_P.

With this configuration, even in a case where the wall material WM has a large size, the preprocessing unit 312 can generate the image P_P1 which includes the entire wall material WM by connecting images captured by the plurality of scanners.

### (Example 2 of Processing Performed by Preprocessing Unit 312)

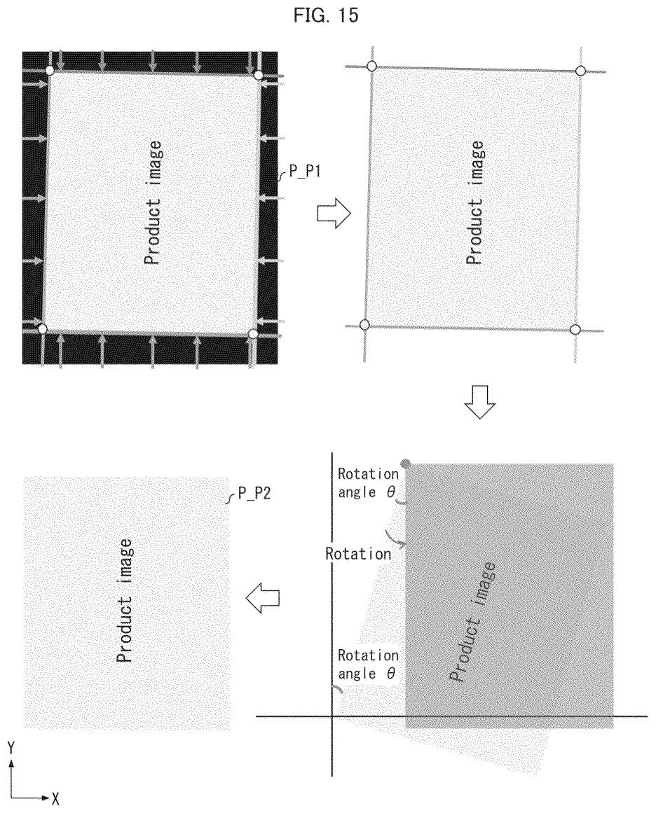

Another example of the processing performed by the preprocessing unit 312 will be described with reference to FIG. 15. FIG. 15 is a view illustrating another example of the processing performed by the preprocessing unit 312. The description of FIG. 15 will assume that a right-left direction of the image P_P1 is an x-axis direction, and a vertical direction thereof is a y-axis direction.

The preprocessing unit 312 corrects an inclination of the wall material WM in the image P_P1 generated by the above-described processing.

First, the preprocessing unit 312 detects the wall material WM, which is a subject, by scanning the image P_P1 from five locations on an upper side of the image P_P1 toward the inner side thereof, as illustrated at the upper left corner of FIG. 15. Next, the preprocessing unit 312 connects five points obtained by the detection of the wall material WM with a straight line. That is, the preprocessing unit 312 detects an upper side of the wall material WM in the image P_P1. Similarly, the preprocessing unit 312 detects the wall material WM by scanning the image P_P1 from five locations on each of the remaining sides, i.e. a left side, a right side, and a lower side, of the image P_P1 toward the inner side thereof to detect a left side, a right side, and a lower side of the wall material WM. Then, the preprocessing unit 312 extracts the wall material WM in the image P_P1, as illustrated at the upper right corner of FIG. 15.

Subsequently, the preprocessing unit 312 uses the inverse trigonometric function to calculate a rotation angle θ that makes the upper side and the lower side of the wall material WM in the image P_P1 parallel to an x-axis and makes the left side and the right side of the wall material WM in the image P_P1 parallel to a y-axis, as illustrated at the lower right corner of FIG. 15. Then, the preprocessing unit 312 generates an image P_P2 which is obtained by rotating the wall material WM in the image P_P1 with the rotation angle θ, as illustrated at the lower left corner of FIG. 15.

With this configuration, even in a case where a plurality of images captured of the wall material WM have different inclinations, the preprocessing unit 312 can generate the image P_P2 in which the images of the wall material WM have equal inclinations.

### (Example 3 of Processing Performed by Preprocessing Unit 312)

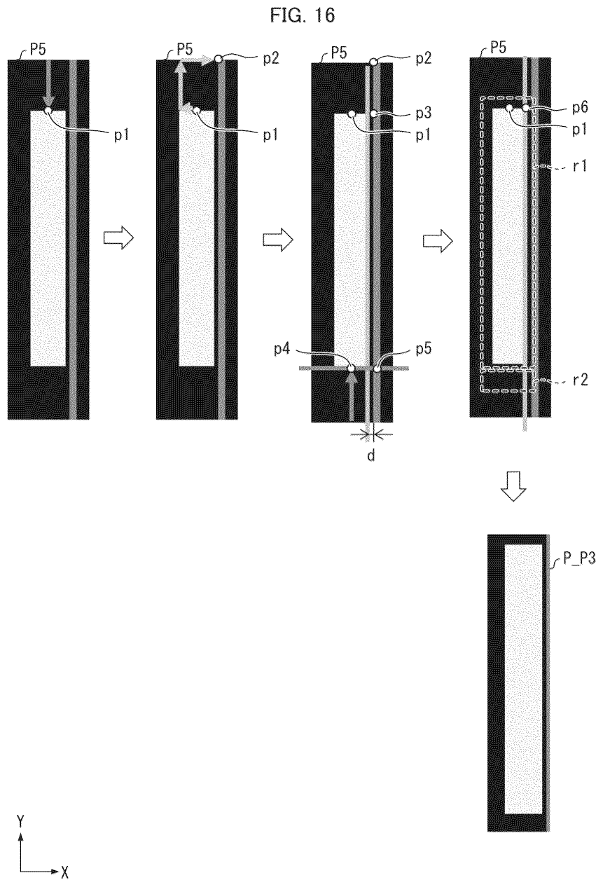

Still another example of the processing performed by the preprocessing unit 312 will be described with reference to FIG. 16. FIG. 16 is a view illustrating still another example of the processing performed by the preprocessing unit 312. The description of FIG. 16 will also assume that a right-left direction of an image P10 is an x-axis direction, and a vertical direction thereof is a y-axis direction.

The following will describe processing in which the preprocessing unit 312 carries out alignment of the wall material WM by taking, as an example, an image P5 captured of a wall material WM from a lateral surface as in the case of the scanner SC_3, the scanner SC_4, the scanner SC_7, and the scanner SC_8 in the above-described inspection system of FIG. 5.

First, the preprocessing unit 312 detects the wall material WM, which is a subject, by scanning the image P5 from an upper side of the image P5 toward the inner side thereof, as illustrated at the upper left corner of FIG. 16. The preprocessing unit 312 sets a detected point as a point p1.

Next, the preprocessing unit 312 detects a corner of the wall material WM by scanning the image P5 from the point p1 in the left direction along the x-axis, as illustrated in the drawing located on the right side of the drawing at the upper left corner of FIG. 16. After having detected the corner of the wall material WM, the preprocessing unit 312 scans the image P5 from the corner of the wall material WM in the upward direction along the y-axis until an upper side of the image P5 is reached. After having scanned the image P5 until the upper side of the image P5 is reached, the preprocessing unit 312 detects the conveyor by scanning the image P5 in the right direction along the x-axis. The preprocessing unit 312 sets a detected point as a point p2.

Subsequently, the preprocessing unit 312 sets, as p3, an intersection point of a line passing through the point p1 and being parallel to the x-axis and a straight line passing through the point p2 and being parallel to the y-axis, as illustrated in the drawing located on the left side of the drawing at the upper right corner of FIG. 16. Further, the preprocessing unit 312 detects the wall material WM, which is a subject, by scanning the image P5 from a lower side of the image P5 toward the inner side thereof, as in the case of the upper side of the image P5. The preprocessing unit 312 sets a detected point as a point p4. Then, the preprocessing unit 312 sets, as p5, an intersection point of a line passing through the point P4 and being parallel to the x-axis and a straight line passing through the point p2 and being parallel to the y-axis. The preprocessing unit 312 calculates a distance d between the straight line passing through the point p3 and the point p5 and the wall material WM. The preprocessing unit 312 may calculate distances between a plurality of points and the wall material WM and calculate an average of the distances as the distance d.

Furthermore, the preprocessing unit 312 sets, as the right side of the wall material WM, a straight line that has straightness and is parallel to the y-axis and that is separated by the distance d in the left direction along the x-axis from the straight line passing through the points p3 and p5 thus calculated. Subsequently, as illustrated at the upper right corner of FIG. 16, the preprocessing unit 312 sets, as a point p6, a point that is on the right side of the wall material WM and that is an upper right corner of the wall material WM, sets a region r1 to be cut out with a margin having a predetermined length from the point p6. Here, the preprocessing unit 312 may set the margin on the basis of a division size (size of the small images) obtained by the division unit 313. For example, the preprocessing unit 312 may set, as a region to be cut out, a region that is obtained by adding a region r2 to the region r1 so that the region to be cut out has a length which is an integral multiple of the division size obtained by the division unit 313.

Then, as illustrated at the lower right corner of FIG. 16, the preprocessing unit 312 carries out cutting from the image P5 on the basis of the set region to be cut out to generate the image P_P3 which has been subjected to the alignment of the wall material WM.

With this configuration, even in a case where the respective positions of the wall material WM in the plurality of images captured of the wall material WM are different, the preprocessing unit 312 can generate the image P_P3 which has been subjected to the alignment of the wall material WM.

### (Example 1 of Processing Performed by Division Unit 313)

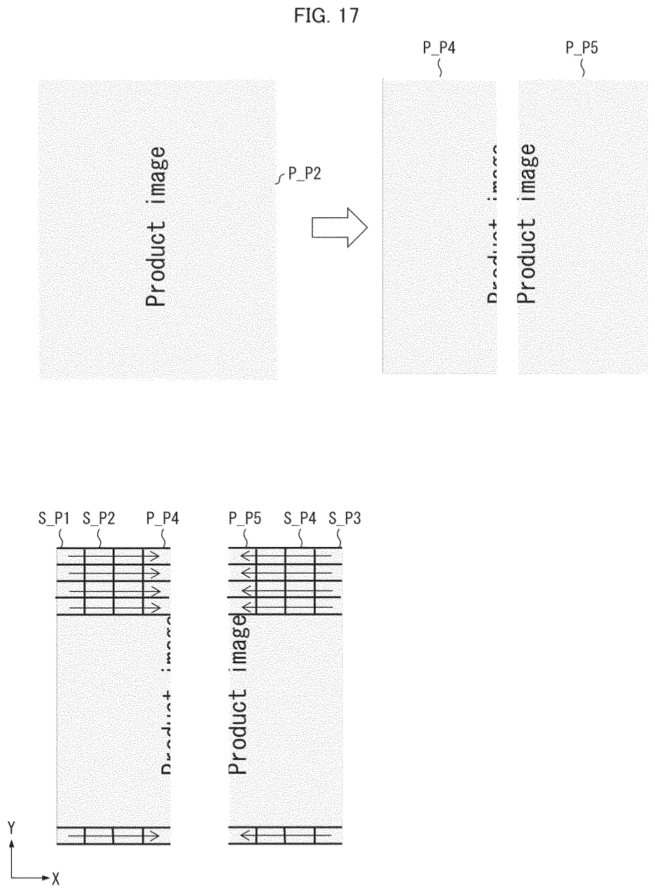

An example of the processing performed by the division unit 313 will be described with reference to FIG. 17. FIG. 17 is a view illustrating an example of the processing performed by the division unit 313. The following will describe processing for dividing the image P_P2 which has been generated by the preprocessing unit 312 in the above-described processing. The description of FIG. 17 will also assume that a right-left direction of the image P_P2 is an x-axis direction, and a vertical direction thereof is a y-axis direction.

First, as illustrated at the upper right corner of FIG. 17, the division unit 313 divides the image P_P2 into two in a direction parallel to the y-axis to generate images P_P4 and P_P5.

Next, the division unit 313 sets, as a division position from which division is started, an upper left corner of the image P_P4 and generates a small image S_P1 that is obtained by division to a predetermined size. Next, the division unit 313 generates a small image S_P2 that is obtained by division to a predetermined size at a division position as which a point obtained by sliding in the right direction in parallel to the x-axis by an amount corresponding to a predetermined length is set.

In a case where the point (division position) obtained by sliding in the right direction in parallel to the x-axis by the amount corresponding to the predetermined length has gone beyond the image P_P4, the division unit 313 generates an image that is obtained by division, to a predetermined size, at a division position as which a point obtained by sliding downward in the y-axis direction by an a amount corresponding to predetermined length from the upper left corner of the image P_P4 is set, as in the above-described processing operation.

The division unit 313 repeats these processing operations to generate, from the image P_P4, a plurality of small images S_P into which the image P_P4 has been divided.

With regard to the image P_P5, the division unit 313 sets, as a division position, an upper right corner of the image P_P5 and generates a small image S_P3 that is obtained by division to a predetermined size. Next, the division unit 313 generates a small image S_P4 that is obtained by division to a predetermined size at a division position as which a point obtained by sliding in the left direction in parallel to the x-axis by an amount corresponding to a predetermined length is set.

In a case where the point (division position) obtained by sliding in the left direction in parallel to the x-axis by the amount corresponding to the predetermined length has gone beyond the image P_P5, the division unit 313 generates an image that is obtained by division, to a predetermined size, at a division position as which a point obtained by sliding downward in the y-axis direction by an amount corresponding to a predetermined length from the upper right corner of the image P_P5 is set, as in the above-described processing operation.

The division unit 313 repeats these processing operations to generate, from the image P_P5, a plurality of small images S_P into which the image P_P5 has been divided.

### (Example 2 of Processing Performed by Division Unit 313)

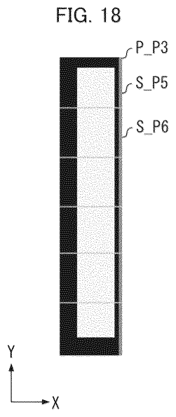

Another example of the processing performed by the division unit 313 will be described with reference to FIG. 18. FIG. 18 is a view illustrating another example of the processing performed by the division unit 313. The following will describe processing for dividing the image P_P3 which has been generated by the preprocessing unit 312 in the above-described processing. The description of FIG. 18 will also assume that a right-left direction of the image P_P3 is an x-axis direction, and a vertical direction thereof is a y-axis direction.

The division unit 313 sets, as a division position, an upper left corner of the image P_P3 and generates a small image S_P5 that is obtained by division to a predetermined size. Next, the division unit 313 generates a small image S_P6 that is obtained by division to a predetermined size at a division position as which a point obtained by sliding downward in parallel to the y-axis by an amount corresponding to a predetermined length is set.

The division unit 313 repeats these processing operations to generate, from the image P_P3, a plurality of small images S_P into which the image P_P3 has been divided.

### (First Machine Learning Model M1 and Second Machine Learning Model M2)

Examples of the first machine learning model M1 and the second machine learning model M2 will be described.

As described above, the first machine learning model M1 is a machine learning model that has been trained by machine learning with use of, as training data, a set of an image of a normal wall material WM which includes no defect and a determination result indicating that the wall material WM is normal. Examples of the first machine learning model M1 include the following four first machine learning models:
A first machine learning model M1_1 that has been trained by machine learning with use of, as training data, a set of a small image which is an image captured by a scanner and including the wall material WM as a subject and which has been obtained by division by the division unit 313 and a determination result indicating that the wall material WM is normal.
A first machine learning model M1_2 that has been trained by machine learning with use of, as training data, a set of a small image which is an image captured by a scanner and including the wall material WM as a subject and which has been obtained by division by the division unit 313 and has been further subjected to edge processing by the preprocessing unit 312 and a determination result indicating that the wall material WM is normal.
A first machine learning model M1_3 that has been trained by machine learning with use of, as training data, a set of a small image which is an image captured by a scanner and including the wall material WM as a subject and which has been obtained by division by the division unit 313 and has been further subjected to enhancement with a specific color by the preprocessing unit 312 and a determination result indicating that the wall material WM is normal.
A first machine learning model M1_4 that has been trained by machine learning with use of, as training data, a set of a 3D small image which is a 3D image captured by a 3D scanner and including the wall material WM as a subject and which has been obtained by division by the division unit 313 and a determination result indicating that the wall material WM is normal.

The second machine learning model M2 is a machine learning model that has been trained by machine learning with use of, as training data, a set of an image of a normal wall material WM and a determination result indicating that the wall material WM is normal and a set of an image of a defective wall material WM and a determination result indicating that the wall material WM is defective. Examples of the second machine learning model M2 include the following two second machine learning models:
A second machine learning model M2_1 that has been trained by machine learning with use of, as training data, a set of a small image which is an image captured by a scanner and including the wall material WM as a subject and which has been obtained by division by the division unit 313 and a determination result indicating that the wall material WM is normal and a set of a small image which is an image captured by a scanner and including the wall material WM as a subject and which has been obtained by division by the division unit 313 and a determination result indicating that the wall material WM is defective.
A second machine learning model M2_2 that has been trained by machine learning with use of, as training data, a set of a 3D small image which is a 3D image captured by a 3D scanner and including the wall material WM as a subject and which has been obtained by division by the division unit 313 and a determination result indicating that the wall material WM is normal and a set of a 3D small image which is a 3D image captured by a 3D scanner and including the wall material WM as a subject and which has been obtained by division by the division unit 313 and a determination result indicating that the wall material WM is defective.

Thus, the quality inspection system 1A uses machine learning models that have been trained by machine learning with use of various images, as training data, such as an image captured by a 2D scanner, an image captured by a 3D scanner, an image not subjected to preprocessing, an image subjected to preprocessing, an image of a normal wall material WM, and an image of a defective wall material WM. Further, the machine learning models include at least one one-class model (first machine learning model M1) and at least one multi-class model (second machine learning model M2). Therefore, in the quality inspection system 1A, it is possible to accurately detect various defects (such as a scratch and a dent) made in the wall material WM.

### (Examples of Combination of Determination Results)

Examples of a combination of determination results to be referred to by the detection unit 314 will be described. The following will describe examples of a combination of determination results from the machine learning model described above. Further, each machine learning model and the determination result (“good” or “no good”) will be referred to as follows:
A determination result R1 obtained by the first machine learning model M1_1
A determination result R2 obtained by the first machine learning model M1_2
A determination result R3 obtained by the first machine learning model M1_3
A determination result R4 obtained by the second machine learning model M2_1
A determination result R5 obtained by the first machine learning model M1_4
A determination result R6 obtained by the second machine learning model M2_2

As described above, the detection unit 314 detects a defect included in the wall material WM by performing logical operations on the at least two determination results. As an example, a defect included in the wall material WM is detected by using the following formula (1):

Detection result=R1 and (R2 or R3) or R4 or R5 or R6 (1)

In a case where the detection result obtained by the above-described formula (1) is “good”, the detection unit 314 stores, in the storage unit 32, a detection result indicating that the wall material WM includes no defect. On the other hand, in a case where the detection result obtained by the above-described formula (1) is “no good”, the detection unit 314 stores, in the storage unit 32, a detection result indicating that the wall material WM includes a defect.

In addition, as described above, the detection unit 314 may change, in accordance with the type of the wall material WM, the combination of the at least two determination results to be referred to. For example, the detection unit 314 may change the combination by referring to a table in which the type of the wall material WM and a formula indicating the combination are associated with each other. As an example, the detection unit 314 specifies the type of the wall material WM on the basis of a product number input to the interface IF2 of the image DP1 described above.

For example, in a case where the wall material WM is a product A, the detection unit 314 detects a defect included in the wall material WM by using the above-described formula (1):

Detection result=R1 and (R2 or R3) or R4 or R5 or R6 (1)

Further, in a case where the wall material WM is a product B, the detection unit 314 detects a defect included in the wall material WM by using the following formula (2):

Detection result=(R1 and R2 and R3) or R4 or R5 or R6 (2)

Further, in a case where the wall material WM is a product C, the detection unit 314 detects a defect included in the wall material WM by using the following formula (3):

Detection result=R2 or (R3 and R1) or R4 or R5 or R6 (3)

Similarly, in a case where the detection result obtained by each of the above-described formulas is “good”, the detection unit 314 stores, in the storage unit 32, a detection result indicating that the wall material WM includes no defect. On the other hand, in a case where the detection result obtained by each of the above-described formulas is “no good”, the detection unit 314 stores, in the storage unit 32, a detection result indicating that the wall material WM includes a defect.

In this way, the detection unit 314 changes, in accordance with the type of the wall material WM, the combination of the at least two determination results to be referred to. Thus, the detection unit 314 can detect a defect in accordance with the type of the wall material WM. Further, the detection unit 314 detects a defect included in the wall material WM by performing logical operations on the at least two determination results. Thus, the detection unit 314 can detect a defect in accordance with the content of the determination of each determination result.

(Effect Brought about by Quality Inspection System 1A)

Thus, the quality inspection system 1A detects a defect included in the wall material WM by referring to a combination of at least two determination results which have been obtained by inputting small images S_P, which have been obtained by division of the wall material WM, into the first machine learning model M1 and the second machine learning model M2 that have been trained by different training methods. Therefore, the quality inspection system 1A detects a defect with use of the small images S_P obtained by dividing an image including the wall material WM having a large size as a subject and thus makes it possible to detect a small defect in the wall material WM.

Further, the quality inspection system 1A divides the wall material WM into a plurality of small images. Then, the quality inspection system 1A outputs an image in which a defective part is shown. Thus, the quality inspection system 1A can present to the user not only whether or not there is a defect in the wall material WM but also where there is a defect in the wall material WM.

### Third Example Embodiment

A third example embodiment which is an example of an embodiment of the present invention will be described in detail with reference to the drawings. The same reference numerals are given to constituent elements which have functions identical with those described in the above-described example embodiment, and descriptions as to such constituent elements are omitted as appropriate. The scope of the application of the technical means employed in the present example embodiment is not limited to the present example embodiment. That is, each technical means employed in the present example embodiment can also be employed in other example embodiments included in the present disclosure to the extent that no particular technical obstruction occurs. In addition, each technical means illustrated in the drawings which are referred to for the description of the present example embodiment can also be employed in other example embodiments included in the present disclosure to the extent that no particular technical obstruction occurs.

### (Configuration of Quality Inspection Apparatus 2A)

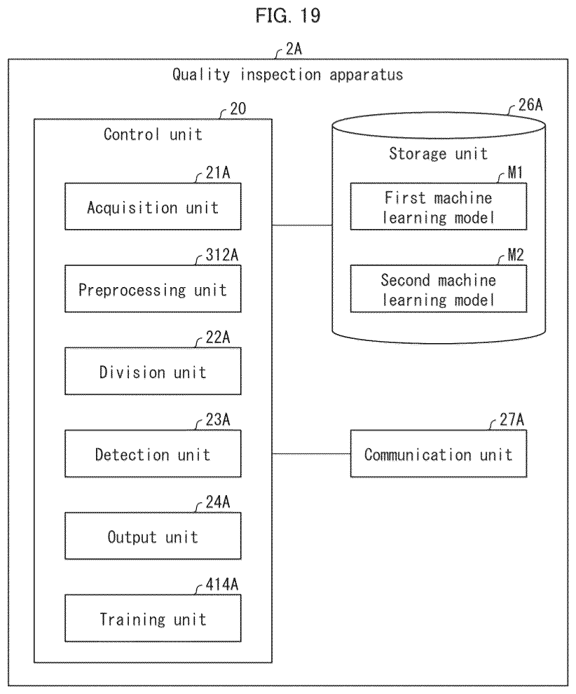

A configuration of a quality inspection apparatus 2A will be described with reference to FIG. 19. FIG. 19 is a block diagram illustrating the configuration of the quality inspection apparatus 2A.

The quality inspection apparatus 2A includes a control unit 20, a storage unit 26A, and a communication unit 27A, as illustrated in FIG. 19.

The storage 1 unit 26A stores data to be referred to by the control unit 20. Examples of the data stored in the storage unit 26A include the first machine learning model M1 and the second machine learning model M2. In this case, the storage unit 26A may store respective parameters defining the first machine learning model M1 and the second machine learning model M2. Examples of the storage unit 26A include, but not limited to, a flash memory, an HDD, an SSD, and a combination of these.

The communication unit 27A is an interface that transmits and receives data via a network. As an example, the communication unit 27A transmits, to another apparatus, data supplied from the control unit 20 and supplies, to the control unit 20, data received from another apparatus. Examples of the communication unit 27A include, but not limited to, a communication chip in various communication standards such as Ethernet, Wi-Fi, and radio communications standard for mobile data communications networks, and a USB-compliant connector.

### (Control Unit 20)

The control unit 20 controls constituent elements included in the quality inspection apparatus 2A.

Further, the control unit 20 includes an acquisition unit 21A, a preprocessing unit 312A, a division unit 22A, a detection unit 23A, an output unit 24A, and a training unit 414A, as illustrated in FIG. 19. The acquisition unit 21A, the preprocessing unit 312A, the division unit 22A, the detection unit 23A, the output unit 24A, and the training unit 414A realize an acquisition means, a preprocessing means, a division means, a detection means, an output means, and a training means, respectively, in the present example embodiment.

The acquisition unit 21A includes the configurations of the acquisition unit 21 and the acquisition unit 311 described above and acquires an image captured of a wall material WM. The acquisition unit 21 stores the acquired image in the storage unit 26A.

The preprocessing unit 312A includes the configuration of the preprocessing unit 312 described above and performs processing (preprocessing) on an image. An example of a process for the preprocessing unit 312A performing preprocessing on an image is as described above. The preprocessing unit 312A stores the processed data in the storage unit 26A.

The division unit 22A includes the configurations of the division units 22 and 313 described above and divides the image processed by the preprocessing unit 312A into a plurality of small images. An example of a process for the division unit 22A dividing an image is as described above. The division unit 22A stores, in the storage unit 26A, the plurality of small images obtained by the division.

The detection unit 23A includes the configurations of the detection units 23 and 314 described above and detects a defect included in the wall material WM by referring to a combination of at least two determination results which have been obtained by inputting small images, which have been obtained by the division carried out by the division unit 22A, into each of at least one first machine learning model M1 and at least one second machine learning model M2. An example of a process for the detection unit 23A detecting a defect is as described above. The detection unit 23A stores a detection result in the storage unit 26A.

The output unit 24A includes the configurations of the output units 24 and 315 described above and outputs the detection result obtained by the detection unit 23A.

The training unit 414A includes the configuration of the training unit 414 described above and trains the first machine learning model M1 and the second machine learning model M2. An example of the training of the first machine learning model M1 and the second machine learning model M2 by the training unit 414A is as described above.

(Effect Brought about by Quality Inspection Apparatus 2A)

Thus, the quality inspection apparatus 2A detects a defect included in the wall material WM by referring to a combination of at least two determination results which have been obtained by inputting small images, which have been obtained by division of the wall material WM, into the first machine learning model M1 and the second machine learning model M2 that have been trained by different training methods. Therefore, the quality inspection apparatus 2A detects a defect with use of an image obtained by dividing an image including the wall material WM having a large size as a subject and thus makes it possible to detect a small defect in the wall material WM.

### Software Implementation Example

Some or all of the functions of the quality inspection system 1, the quality inspection apparatuses 2, 2A, the AP/DB server 3, and the determination server 4 (hereinafter also referred to as “the above-described apparatuses”) can be realized by hardware such as an integrated circuit (IC chip) or can be alternatively realized by software.

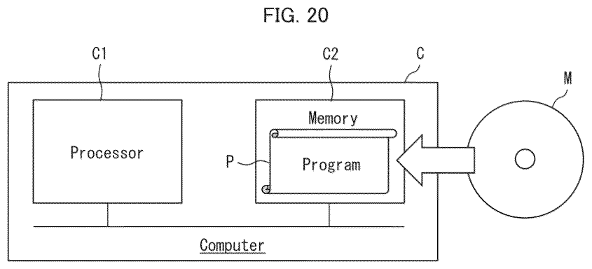

In the latter case, the above-described apparatuses are each realized by, for example, a computer that executes instructions of a program that is software realizing the foregoing functions. FIG. 20 illustrates an example of such a computer (hereinafter referred to as “computer C”). FIG. 20 is a block diagram illustrating a hardware configuration of the computer C that functions as the above-described apparatuses.

The computer C includes at least one processor C1 and at least one memory C2. The at least one memory C2 stores a program P for causing the computer C to operate as the above-described apparatuses. In the computer C, the processor C1 reads the program P from the memory C2 and executes the program P, so that the functions of the above-described apparatuses are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. As the memory C2, for example, it is possible to use a flash memory, a hard disk drive (HDD), a solid state drive (SSD), or a combination of these.

Note that the computer C can further include a random access memory (RAM) in which the program P is loaded at the execution of the program P and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

Further, the above-described functions of the above-described apparatuses may be realized by a single processor provided in a single computer, may be realized by causing a plurality of processors provided in a single computer to operate together, or may be realized by causing a plurality of processors provided in a plurality of corresponding computers to operate together. Further, a program for causing the above-described apparatuses to realize the above-described functions may be stored in a single memory provided in a single computer, may be stored dispersedly in a plurality of memories provided in a single computer, or may be stored dispersedly in a plurality of memories provided in a plurality of corresponding computers.

### ADDITIONAL REMARK A

The present disclosure includes the techniques described in the supplementary notes below. Note, however, that the present invention is not limited to the techniques described in the supplementary notes below, but may be altered in various ways by a skilled person within the scope of the claims.

### (Supplementary Note A1)

A quality inspection system including:
an acquisition means for acquiring an image captured of a wall material;
a division means for dividing the image into a plurality of small images;
a detection means for detecting a defect included in the wall material by referring to a combination of at least two determination results which have been obtained by inputting the small images into each of at least two machine learning models that have been trained by different training methods and that each use, as input, an image captured of a wall material and output a determination result which is obtained by determining whether or not the wall material is defective; and
an output means for outputting a detection result which is obtained by the detection means.

### (Supplementary Note A2)

The quality inspection system described in supplementary note A1, wherein the at least two machine learning models include:
at least one first machine learning model that has been trained by machine learning with use of, as training data, a set of an image of a normal wall material which includes no defect and a determination result indicating that the normal wall material is normal; and
at least one second machine learning model that has been trained by machine learning with use of, as training data, a set of an image of a normal wall material and a determination result indicating that the normal wall material is normal and a set of an image of a defective wall material and a determination result indicating that the defective wall material is defective.

### (Supplementary Note A3)

The quality inspection system described in supplementary note A1 or A2, wherein
the detection means is configured to change, in accordance with a type of the wall material, the combination of the at least two determination results to be referred to.

### (Supplementary Note A4)

The quality inspection system described in any of supplementary notes A1 to A3, wherein
the detection means is configured to detect the defect included in the wall material by performing logical operations on the at least two determination results.

### (Supplementary Note A5)

The quality inspection system described in any of supplementary notes A1 to A4, further including a preprocessing means for carrying out at least one selected from the group consisting of connection between images acquired by the acquisition means, inclination correction of the wall material in an image acquired by the acquisition means, alignment of the wall material in an image acquired by the acquisition means, color processing on an image acquired by the acquisition means, and edge processing on an image acquired by the acquisition means, wherein
the division means is configured to divide, into a plurality of small images, the image that has been processed by the preprocessing means.

### (Supplementary Note A6)

The quality inspection system described in any of supplementary notes A1 to A5, wherein
the output means is configured to output an image in which a defective part is shown.

### (Supplementary Note A7)

The quality inspection system described in supplementary note A6, wherein
the detection result includes at least one selected from the group consisting of information indicating whether or not an outer dimension of the wall material falls within a threshold range and information indicating whether or not a value of a pixel value of the wall material in an image acquired by the acquisition means falls within a threshold range.

### (Supplementary Note A8)

The quality inspection system described in any of supplementary notes A1 to A7, further including a training means for training the first machine learning model and the second machine learning model.

### (Supplementary Note A9)

A quality inspection apparatus including:
an acquisition means for acquiring an image captured of a wall material;
a division means for dividing the image into a plurality of small images;
a detection means for detecting a defect included in the wall material by referring to a combination of at least two determination results which have been obtained by inputting the small images into each of at least two machine learning models that have been trained by different training methods and that each use, as input, an image captured of a wall material and output a determination result which is obtained by determining whether or not the wall material is defective; and
an output means for outputting a detection result which is obtained by the detection means.

### (Supplementary Note A10)

A training system including:
an acquisition means for acquiring an image captured of a wall material;
a division means for dividing the image into a plurality of small images; and
a training means for training, by different training methods, at least two machine learning models that each use, as input, an image captured of a wall material and output a determination result which is obtained by determining whether or not the wall material is defective.

### (Supplementary Note A11)

A training apparatus including:
an acquisition means for acquiring an image captured of a wall material;
a division means for dividing the image into a plurality of small images; and
a training means for training, by different training methods, at least two machine learning models that each use, as input, an image captured of a wall material and output a determination result which is obtained by determining whether or not the wall material is defective.

### ADDITIONAL REMARK B

The present disclosure includes the techniques described in the supplementary notes below. Note, however, that the present invention is not limited to the techniques described in the supplementary notes below, but may be altered in various ways by a skilled person within the scope of the claims.

### (Supplementary Note B1)

A quality inspection method including:
an acquisition process for at least one processor acquiring an image captured of a wall material;
a division process for the at least one processor dividing the image into a plurality of small images;
a detection process for the at least one processor detecting a defect included in the wall material by referring to a combination of at least two determination results which have been obtained by inputting the small images into each of at least two machine learning models that have been trained by different training methods and that each use, as input, an image captured of a wall material and output a determination result which is obtained by determining whether or not the wall material is defective; and
an output process for the at least one processor outputting a detection result which is obtained in the detection process.

### (Supplementary Note B2)

The quality inspection method described in supplementary note B1, wherein
the at least two machine learning models include:
at least one first machine learning model that has been trained by machine learning with use of, as training data, a set of an image of a normal wall material which includes no defect and a determination result indicating that the normal wall material is normal; and
at least one second machine learning model that has been trained by machine learning with use of, as training data, a set of an image of a normal wall material and a determination result indicating that the normal wall material is normal and a set of an image of a defective wall material and a determination result indicating that the defective wall material is defective.

### (Supplementary Note B3)

The quality inspection method described in supplementary note B1 or B2, wherein
in the detection process, the at least one processor changes, in accordance with a type of the wall material, the combination of the at least two determination results to be referred to.

### (Supplementary Note B4)

The quality inspection method described in any of supplementary notes B1 to B3, wherein
in the detection process, the at least one processor detects the defect included in the wall material by performing logical operations on the at least two determination results.

### (Supplementary Note B5)

The quality inspection method described in any of supplementary notes B1 to B4, further including a preprocessing process for the at least one processor carrying out at least one selected from the group consisting of connection between images acquired in the acquisition process, inclination correction of the wall material in an image acquired in the acquisition process, alignment of the wall material in an image acquired in the acquisition process, color processing on an image acquired in the acquisition process, and edge processing on an image acquired in the acquisition process, wherein
in the division process, the at least one processor divides, into a plurality of small images, the image that has been processed in the preprocessing process.

### (Supplementary Note B6)

The quality inspection method described in any of supplementary notes B1 to B5, wherein
in the output process, the at least one processor outputs an image in which a defective part is shown.

### (Supplementary Note B7)

The quality inspection method described in supplementary note B6, wherein
the detection result includes at least one selected from the group consisting of information indicating whether or not an outer dimension of the wall material falls within a threshold range and information indicating whether or not a value of a pixel value of the wall material in an image acquired in the acquisition process falls within a threshold range.

### (Supplementary Note B8)

The quality inspection method described in any of supplementary notes B1 to B7, further including a training process for the at least one processor training the first machine learning model and the second machine learning model.

### (Supplementary Note B9)

A training method including:
an acquisition process for at least one processor acquiring an image captured of a wall material;
a division process for the at least one processor dividing the image into a plurality of small images; and
a training process for the at least one processor training, by different training methods, at least two machine learning models that each use, as input, an image captured of a wall material and output a determination result which is obtained by determining whether or not the wall material is defective.

### ADDITIONAL REMARK C

The present disclosure includes the techniques described in the supplementary notes below. Note, however, that the present invention is not limited to the techniques described in the supplementary notes below, but may be altered in various ways by a skilled person within the scope of the claims.

### (Supplementary Note C1)

A quality inspection program for causing a computer to function as a quality inspection system,
the quality inspection program causing the computer to function as:
an acquisition means for acquiring an image captured of a wall material;
a division means for dividing the image into a plurality of small images;
a detection means for detecting a defect included in the wall material by referring to a combination of at least two determination results which have been obtained by inputting the small images into each of at least two machine learning models that have been trained by different training methods and that each use, as input, an image captured of a wall material and output a determination result which is obtained by determining whether or not the wall material is defective; and
an output means for outputting a detection result which is obtained by the detection means.

### (Supplementary Note C2)

The quality inspection program described in supplementary note C1, wherein
the at least two machine learning models include:
at least one first machine learning model that has been trained by machine learning with use of, as training data, a set of an image of a normal wall material which includes no defect and a determination result indicating that the normal wall material is normal; and
at least one second machine learning model that has been trained by machine learning with use of, as training data, a set of an image of a normal wall material and a determination result indicating that the normal wall material is normal and a set of an image of a defective wall material and a determination result indicating that the defective wall material is defective.

### (Supplementary Note C3)

The quality inspection program described in supplementary note C1 or C2, wherein
the detection means is configured to change, in accordance with a type of the wall material, the combination of the at least two determination results to be referred to.

### (Supplementary Note C4)

The quality inspection program described in any of supplementary notes C1 to C3, wherein
the detection means is configured to detect the defect included in the wall material by performing logical operations on the at least two determination results.

### (Supplementary Note C5)

The quality inspection program described in any of supplementary notes C1 to C4, wherein:
the quality inspection program causes the computer to further function as a preprocessing means for carrying out at least one selected from the group consisting of connection between images acquired by the acquisition means, inclination correction of the wall material in an image acquired by the acquisition means, alignment of the wall material in an image acquired by the acquisition means, color processing on an image acquired by the acquisition means, and edge processing on an image acquired by the acquisition means; and
the division means is configured to divide, into a plurality of small images, the image that has been processed by the preprocessing means.

### (Supplementary Note C6)

The quality inspection program described in any of supplementary notes C1 to C5, wherein
the output means is configured to output an image in which a defective part is shown.

### (Supplementary Note C7)

The quality inspection program described in supplementary note C6, wherein
the detection result includes at least one selected from the group consisting of information indicating whether or not an outer dimension of the wall material falls within a threshold range and information indicating whether or not a value of a pixel value of the wall material in an image acquired by the acquisition means falls within a threshold range.

### (Supplementary Note C8)

The quality inspection program described in any of supplementary notes C1 to C7,
the quality inspection program causing the computer to further function as a training means for training the first machine learning model and the second machine learning model.

### (Supplementary Note C9)

A training program for causing a computer to function as a training system,
the training program causing the computer to function as:
an acquisition means for at least one processor acquiring an image captured of a wall material;
a division means for the at least one processor dividing the image into a plurality of small images; and
a training means for the at least one processor training, by different training methods, at least two machine learning models that each use, as input, an image captured of a wall material and output a determination result which is obtained by determining whether or not the wall material is defective.

### ADDITIONAL REMARK D

The present disclosure includes the techniques described in the supplementary notes below. Note, however, that the present invention is not limited to the techniques described in the supplementary notes below, but may be altered in various ways by a skilled person within the scope of the claims.

### (Supplementary Note D1)

A quality inspection system including at least one processor, the at least one processor carrying out:
an acquisition process for acquiring an image captured of a wall material;
a division process for dividing the image into a plurality of small images;
a detection process for detecting a defect included in the wall material by referring to a combination of at least two determination results which have been obtained by inputting the small images into each of at least two machine learning models that have been trained by different training methods and that each use, as input, an image captured of a wall material and output a determination result which is obtained by determining whether or not the wall material is defective; and
an output process for outputting a detection result which is obtained in the detection process.

### (Supplementary Note D2)

The quality inspection system described in supplementary note D1, wherein
the at least two machine learning models include:
at least one first machine learning model that has been trained by machine learning with use of, as training data, a set of an image of a normal wall material which includes no defect and a determination result indicating that the normal wall material is normal; and
at least one second machine learning model that has been trained by machine learning with use of, as training data, a set of an image of a normal wall material and a determination result indicating that the normal wall material is normal and a set of an image of a defective wall material and a determination result indicating that the defective wall material is defective.

### (Supplementary Note D3)

The quality inspection system described in supplementary note D1 or D2, wherein
in the detection process, the at least one processor changes, in accordance with a type of the wall material, the combination of the at least two determination results to be referred to.

### (Supplementary Note D4)

The quality inspection system described in any of supplementary notes D1 to D3, wherein
in the detection process, the at least one processor detects the defect included in the wall material by performing logical operations on the at least two determination results.

### (Supplementary Note D5)

The quality inspection system described in any of supplementary notes D1 to D4, wherein:
the at least one processor further carries out a preprocessing process for carrying out at least one selected from the group consisting of connection between images acquired in the acquisition process, inclination correction of the wall material in an image acquired in the acquisition process, alignment of the wall material in an image acquired in the acquisition process, color processing on an image acquired in the acquisition process, and edge processing on an image acquired in the acquisition process; and
in the division process, the at least one processor divides, into a plurality of small images, the image that has been processed in the preprocessing process.

### (Supplementary Note D6)

The quality inspection system described in any of supplementary notes D1 to D5, wherein
in the output process, the at least one processor outputs an image in which a defective part is shown.

### (Supplementary Note D7)

The quality inspection system described in supplementary note D6, wherein
the detection result includes at least one selected from the group consisting of information indicating whether or not an outer dimension of the wall material falls within a threshold range and information indicating whether or not a value of a pixel value of the wall material in an image acquired in the acquisition process falls within a threshold range.

### (Supplementary Note D8)

The quality inspection system described in any of supplementary notes D1 to D7, wherein
the at least one processor further carries out a training process for training the first machine learning model and the second machine learning model.

### (Supplementary Note D9)

A quality inspection apparatus including at least one processor, the at least one processor carrying out:
an acquisition process for acquiring an image captured of a wall material;
a division process for dividing the image into a plurality of small images;
a detection process for detecting a defect included in the wall material by referring to a combination of at least two determination results which have been obtained by inputting the small images into each of at least two machine learning models that have been trained by different training methods and that each use, as input, an image captured of a wall material and output a determination result which is obtained by determining whether or not the wall material is defective; and
an output process for outputting a detection result which is obtained in the detection process.

### (Supplementary Note D10)

A training system including at least one processor, the at least one processor carrying out:
an acquisition process for acquiring an image captured of a wall material;
a division process for dividing the image into a plurality of small images;
a training process for training, by different training methods, at least two machine learning models that each use, as input, an image captured of a wall material and output a determination result which is obtained by determining whether or not the wall material is defective.

### (Supplementary Note D11)

A training apparatus including at least one processor, the at least one processor carrying out:
an acquisition process for acquiring an image captured of a wall material;
a division process for dividing the image into a plurality of small images; and
a training process for training, by different training methods, at least two machine learning models that each use, as input, an image captured of a wall material and output a determination result which is obtained by determining whether or not the wall material is defective.

### ADDITIONAL REMARK E

The present disclosure includes the techniques described in the supplementary notes below. Note, however, that the present invention is not limited to the techniques described in the supplementary notes below, but may be altered in various ways by a skilled person within the scope of the claims.

### (Supplementary Note E1)

A non-transitory storage medium storing a quality inspection program for causing a computer to function as a quality inspection system, the quality inspection program causing the computer to carry out:
an acquisition process for acquiring an image captured of a wall material;
a division process for dividing the image into a plurality of small images;
a detection process for detecting a defect included in the wall material by referring to a combination of at least two determination results which have been obtained by inputting the small images into each of at least two machine learning models that have been trained by different training methods and that each use, as input, an image captured of a wall material and output a determination result which is obtained by determining whether or not the wall material is defective; and
an output process for outputting a detection result which is obtained in the detection process.

### REFERENCE SIGNS LIST

1, 1A: quality inspection system
2, 2A: quality inspection apparatus
3: AP/DB server
4: determination server
11, 21, 21A, 311, 411: acquisition unit
12, 22, 22A, 312, 313: division unit
13, 23, 23A, 314: detection unit
14, 24, 24A, 315, 413: output unit
312, 312A: preprocessing unit
412: determination unit
414, 414A: training unit
M1: first machine learning model
M2: second machine learning model

1. A quality inspection system comprising at least one processor, the at least one processor carrying out:
an acquisition process for acquiring an image captured of a wall material;
a division process for dividing the image into a plurality of small images;
a detection process for detecting a defect included in the wall material by referring to a combination of at least two determination results which have been obtained by inputting the small images into each of at least two machine learning models that have been trained by different training methods and that each use, as input, an image captured of a wall material and output a determination result which is obtained by determining whether or not the wall material is defective; and
an output process for outputting a detection result which is obtained in the detection process.

2. The quality inspection system according to claim 1, wherein
the at least two machine learning models include:
at least one first machine learning model that has been trained by machine learning with use of, as training data, a set of an image of a normal wall material which includes no defect and a determination result indicating that the normal wall material is normal; and
at least one second machine learning model that has been trained by machine learning with use of, as training data, a set of an image of a normal wall material and a determination result indicating that the normal wall material is normal and a set of an image of a defective wall material and a determination result indicating that the defective wall material is defective.

3. The quality inspection system according to claim 1, wherein
in the detection process, the at least one processor changes, in accordance with a type of the wall material, the combination of the at least two determination results to be referred to.

4. The quality inspection system according to claim 1, wherein
in the detection process, the at least one processor detects the defect included in the wall material by performing logical operations on the at least two determination results.

5. The quality inspection system according to claim 1, wherein:
the at least one processor further carries out a preprocessing process for carrying out at least one selected from the group consisting of connection between images acquired in the acquisition process, inclination correction of the wall material in an image acquired in the acquisition process, alignment of the wall material in an image acquired in the acquisition process, color processing on an image acquired in the acquisition process, and edge processing on an image acquired in the acquisition process; and
in the division process, the at least one processor divides, into a plurality of small images, the image that has been processed in the preprocessing process.

6. The quality inspection system according to claim 1, wherein
in the output process, the at least one processor outputs an image in which a defective part is shown.

7. The quality inspection system according to claim 6, wherein
the detection result includes at least one selected from the group consisting of information indicating whether or not an outer dimension of the wall material falls within a threshold range and information indicating whether or not a value of a pixel value of the wall material in an image acquired in the acquisition process falls within a threshold range.

8. A quality inspection method comprising:
an acquisition process for at least one processor acquiring an image captured of a wall material;
a division process for the at least one processor dividing the image into a plurality of small images;
a detection process for the at least one processor detecting a defect included in the wall material by referring to a combination of at least two determination results which have been obtained by inputting the small images into each of at least two machine learning models that have been trained by different training methods and that each use, as input, an image captured of a wall material and output a determination result which is obtained by determining whether or not the wall material is defective; and
an output process for the at least one processor outputting a detection result which is obtained in the detection process.

9. A computer-readable non-transitory storage medium storing a quality inspection program for causing a computer to function as a quality inspection system,
the quality inspection program causing the computer to carry out:
an acquisition process for acquiring an image captured of a wall material;
a division process for dividing the image into a plurality of small images;
a detection process for detecting a defect included in the wall material by referring to a combination of at least two determination results which have been obtained by inputting the small images into each of at least two machine learning models that have been trained by different training methods and that each use, as input, an image captured of a wall material and output a determination result which is obtained by determining whether or not the wall material is defective; and
an output process for outputting a detection result which is obtained in the detection process.
